(19) United States
(12) Patent Application Publication
(10) Pub. No.: US 2015/0114184 A1
(43) Pub. Date: Apr. 30, 2015

(54) BOTTLE OPENER ON WRIST

(71) Applicant: Elvis Padron, YONKERS, NY (US)

(72) Inventor: Mark G. Green, Baldwin, NY (US)

(73) Assignee: Elvis Padron, YONKERS, NY (US)

(21) Appl. No.: 14/523,847

(22) Filed: Oct. 25, 2014

(51) Int. Cl. B67B 7/16

(52) U.S. Cl. CPC B67B 7/16
USPC 81/3.27

(57) ABSTRACT

A tool for removing a crown cork bottle cap from a beer or beverage bottle is disclosed. The tool is a wristband, comprised with an opening component to remove the cap, secured to the wristband. The wristband is made of leather and the opening component is a stainless steel metal plate, used for the removing of the bottle cap, which has been secured between two layers of leather. The wristband consists of straps which can be made adjustable to the user's wrist size.

### BACKGROUND OF THE INVENTION

In the Food and Beverage industry, serving beer bottles, or any other beverage bottle with crown cork bottle caps that keep the beverages closed and secure, comes a need for a device to open the bottles by taking off the caps as fast and efficiently is required. Those who work directly in the process, such as bartenders and wait staff, often find themselves frequently looking for a tool to open these beverage and beer bottles. The caps on these beer bottles require either to be pried off or twisted off by grasping enough of the sharp edges positioned around the bottom edges of the cap. Bartenders and waiters have encountered situations where they cannot find the bottle opener, have misplaced it, or it is not within easy reach. The present invention is a tool that can be worn on the wrist, which acts as an esthetic and efficient tool providing a convenient means to opening beer bottles & other beverages. By allowing the tool to be worn by the user on the wrist, it eliminates the need for a conventional hand-held opener, reduces time of servicing, and reduces the likelihood of misplacing a conventional bottle opener.

The idea for this invention was conceived in South Africa, when drinking at a bar with a bartender and waitress after their busy shift. Like most people, they had pet peeves about their jobs. In this case, it was dropping their hand-held bottle openers all night and because bars are dark, finding them on the floor was a time-consuming and annoying hassle. Addressing this problem seemed simple and so came the idea for a bottle opener that could be easily accessed at all times and without requiring the use of hands.

### BRIEF DESCRIPTION OF DRAWINGS

FIG. 1 illustrates an isometric front view of the embodiment (bottle opener on wrist).

FIG. 2 illustrates a side view of the embodiment illustrated in FIG. 1, if the embodiment were to be placed on a flat surface.

FIG. 3 illustrates an isometric rear view of the embodiment, a clockwise rotated view of FIG. 1.

FIG. 4 illustrates the bottle opener on wrist being worn by a user.

### DETAILED DESCRIPTION OF THE INVENTION

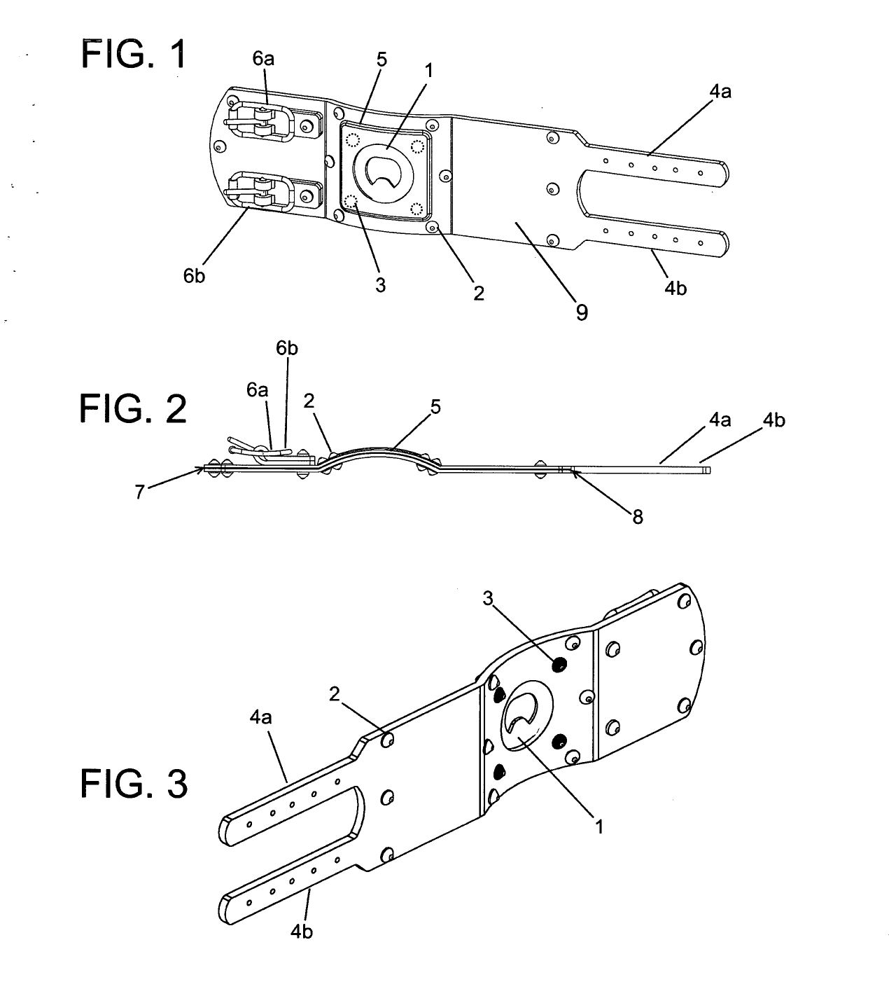

The bottle opener on wrist is designed initially for function, but handcrafted out of 100% genuine leather. FIGS. 1, 2 and 3 illustrate the embodiment, the wristband, in a wide open position. Referring to FIG. 1, 1 displays the opening component, made of laser-cut stainless steel, which is used to execute the actual removing of the crown cap off the bottle. The opening component has a curvature which is made seen in FIG. 2 referring to 5. The opening component, 1, can easily flick off both twist and non-twist bottle caps and is secured under a layer of leather which has been secured and sealed by nickel rivets 3. The main body is currently made of 3 mm thick, vegetable-dyed, leather which is then covered with a thinner, top layer of leather for a smooth exterior, which is available in a variety of different colors. The bottle opener part itself is situated within the layers of leather which are secured by nickel rivets, 2.

The finest buckle on the market is used, the Swedish Buckle, to make sure the wrist bottle opener stays put, with adjustable straps for a perfect fit. The wristband beginning from the end of 7 to the end of 8 is made of two layers of leather. The remaining straps 4a and 4b are only the bottom layer. Referring to FIGS. 1, 2, 3 and 4, 2 displays the rivets that act as a stylish feature, as it can be finished with different studs (i.e. Pyramid studs, flat studs, etc.) The straps, 4a and 4b, fit into their corresponding buckles 6a and 6b, 4a goes into buckle 6a and 4b goes into buckle 6b. The size of the wristband can be adjusted according to the size of the user's wrist by determining which holes in the straps the user would like the buckles to stay on.

A fully functional wrist bottle opener designed and manufactured to be worn on wrist, eliminating the use of hands.

FIG. 1 also shows an area, 9, where features may be added such as placing an LED light, a watch or simply a logo. The space allows the user the option for an additional feature.

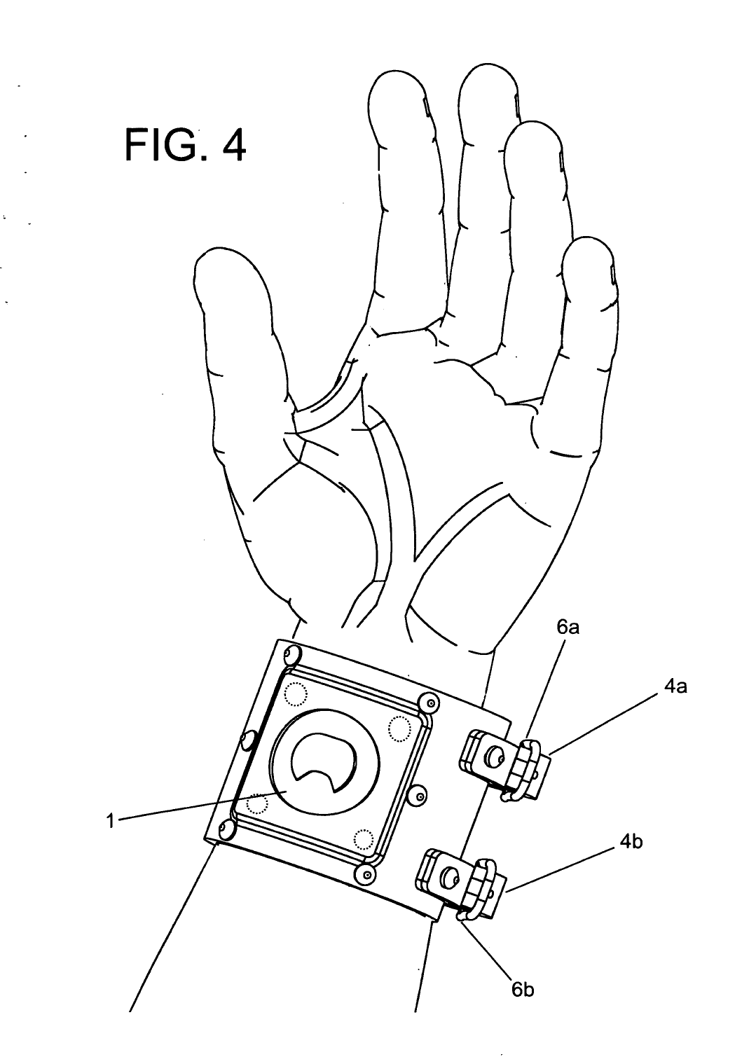

FIG. 4 illustrates the wrist bottle opener on the wrist of a user. 4a has been inserted into buckle 6a and 4b had been inserted into buckle 6b for a designated fit. The user would then place a bottle with a crown cap against 1 and the bottle's cap into the opening of 1 and just like a conventional bottle opener use the force to open the bottle.

1. A fully functional wrist bottle opener designed and manufactured to be worn on the wrist. The wristband is fully customizable according to the size of wrist and personal esthetic preference. The bottle opener part itself is currently made of stainless steel ensuring ease and lifelong optimal functionality.
